(19) United States
(12) Patent Application Publication
(10) Pub. No.: US 2018/0101170 A1
(43) Pub. Date: Apr. 12, 2018

(54) METHOD AND SYSTEM FOR CONTROLLING AN AUTONOMOUS VEHICLE

(71) Applicant: FORD GLOBAL TECHNOLOGIES, LLC, Dearborn, MI (US)

(72) Inventors: Brendan CAWLEY, London (GB); Ka Hei SUEN, Epsom (GB)

(73) Assignee: FORD GLOBAL TECHNOLOGIES, LLC, Dearborn, MI (US)

(21) Appl. No.: 15/782,111

(22) Filed: Oct. 12, 2017

(30) Foreign Application Priority Data
Oct. 12, 2016 (GB) 1617318.9

(51) Int. Cl. G05D 1/00

(52) U.S. Cl. CPC G05D 1/0061; B60W 2540/26; G05D 2201/0213; G05D 1/0088

(57) ABSTRACT

The present disclosure includes a method of controlling an autonomous vehicle. The method comprises determining one or more operational parameters of the vehicle, and an ability of a driver to control one or more systems of the vehicle manually. The method further comprises adjusting a proportion of autonomous control of the vehicle based on the one or more operational parameters and the ability of the driver.

### CROSS-REFERENCE TO RELATED APPLICATIONS

This application claims foreign priority benefits under 35 U.S.C. § 119(a)-(d) to GB Application 1617318.9 filed Oct. 12, 2016, which is hereby incorporated by reference in its entirety.

### TECHNICAL FIELD

This disclosure relates to a method of increasing a proportion of autonomous control depending on a manual control factor.

### BACKGROUND

Modern vehicles may be fitted with a control system capable of controlling autonomously, or at least controlling semi-autonomously, one or more vehicular systems. For example, a vehicle may comprise an autonomous braking system configured to maintain a safe stopping distance between the vehicle and another vehicle ahead of it in traffic. In another example, a vehicle may have an autonomous steering system configured to maintain the position of the vehicle within a particular lane of a highway.

The United States National Highway Traffic Safety Administration (NHTSA) defines vehicle automation as having five levels, which range from Level 0 (No-Automation), where the driver is in complete and sole control of the primary vehicle controls at all times, to Level 4 (Full Self-Driving Automation), where the vehicle is designed to perform all safety-critical driving functions and monitor roadway conditions for an entire trip. A Level 4 vehicle may be configured to allow the driver to provide destination or navigation input, but he or she would not be expected to be available to take over control at any time during the trip.

In addition to autonomous control, it is desirable to set driver/passenger preferences such as vehicle performance, fuel economy and reliability, which may be based on personal demands or governmental legislation, for example. As such, it is desirable to configure an autonomous control system for vehicle such that the driver may transition seamlessly between an autonomous driving mode and a manual driving mode, depending on one or more manual input factors.

### SUMMARY

According to an aspect of the present disclosure there is provided a method to control an autonomous vehicle comprising determining one or more operational parameters of the vehicle, and an ability of a driver to control the vehicle manually. The method also includes adjusting a proportion of autonomous control of the vehicle based on the one or more operational parameters and the ability of the driver.

The one or more operational parameters may result from manual control of at least one of the vehicle control systems.

Determining the one or more operational parameters of the vehicle may comprise at least one of determining a vehicle speed; determining a rate of change of vehicle direction; determining a proximity of the vehicle to one or more other vehicles; determining a proximity of the vehicle to one or more items of road furniture; determining a fuel economy of the vehicle; and determining a route of the vehicle.

Determining an ability of a driver to control the vehicle manually may comprise at least one of: determining conditions of an environment external to the vehicle; determining a physical state of the driver; and determining a functionality of the vehicle.

The method may further comprise selecting a driving mode to define a threshold of the one or more operational parameters; and adjusting the proportion of autonomous control depending on a difference between the one or more operational parameters and the threshold of the one or more operational parameters.

The proportion of autonomous control may be adjusted by an amount proportional to the difference between the one or more operational parameters and the threshold of the one or more operational parameters. The proportion of autonomous control may be increased when the one or more operational parameters are outside of the threshold of the one or more operational parameters.

The driving mode may be selected to maximize the fuel economy of the vehicle. The driving mode may also be selected to maximize driver safety. The driving mode may also be selected to maximize vehicle reliability. The driving mode may also be selected to minimize journey time.

The method may further comprise providing a warning to the driver that the proportion of manual control should be, or is about to be, increased based on the one or more operational parameters and the ability of the driver.

According to another aspect of the present disclosure there is provided an autonomous control system for a vehicle, the system comprising a controller configured to: determine one or more operational parameters of the vehicle; determine the ability of a driver to control the vehicle manually; and adjust the proportion of autonomous control of the vehicle based on the one or more operational parameters and the ability of the driver.

The one or more operational parameters may result from manual control of at least one of the vehicle control systems.

The control system may further comprise one or more sensors operatively connected to the controller. The one or more sensors are configured to determine at least one operational parameter corresponding to: a vehicle speed; a rate of change of vehicle direction; a proximity of the vehicle to one or more other vehicles; a proximity of the vehicle to one or more items of road furniture; a fuel economy of the vehicle; and/or a route of the vehicle.

The control system may further comprise one or more sensors operatively connected to the controller. The one or more sensors are configured to determine the ability of a driver to control the vehicle manually by virtue of determining at least one of: conditions of an environment external to the vehicle; a physical state of the driver; and a functionality of the vehicle.

In the context of the present disclosure, the term “physical state” of the driver is understood to mean a physical position of the driver, for example the position of the driver's head, legs and/or arms. Additionally or alternatively, the “physical state” may be an emotional condition of the driver. For example, the method may comprise determining the physiological signs of stress and/or excitement of the driver. The physiological signs of stress and/or excitement may be used to determine a level of enjoyment of the driver whilst operating the vehicle. The physiological signs may be determined using one or more appropriate methods, which include, but are not limited to, measuring a change in at least one of the electrical conductivity of the skin of the driver, the driver's heart rate, e.g. speed and/or regularity, pupillary dilation and/or blood oxygenation, and/or recording changes in a facial expression of the driver. Additionally or alternatively, the physiological signs may be determined using an electroencephalogram, electromyography, and/or an electrocardiogram. Macro data, such as deviation from behavior trends, spoken words, gaze monitoring, and/or inner ambient conditions of the vehicle may be used to provide useful data regarding the “physical state” of the driver. For example, an imaging system may be used to determine if a driver is smiling, focused, stressed, confused and/or angry. In this manner, the ability of a driver to control the vehicle manually may be determined based on at least one physiological sign of the driver.

A vehicle may be provided comprising one or more of the above-mentioned system integrated with the vehicle.

The invention also provides software, such as a computer program or a computer program product for carrying out any of the methods described herein, and a computer readable medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

For a better understanding of the present disclosure, and to show more clearly how it may be carried into effect, reference will now be made, by way of example, to the accompanying drawings, in which:

### BRIEF DESCRIPTION OF THE DRAWINGS

FIG. 1 shows a graphical representation of a proposition of autonomous control of a vehicle as a function of a manual input factor; and

FIG. 2 shows a flowchart depicting a method to control an autonomous vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In certain situations, it is desirable to adjust the level of autonomous control of a vehicle. For example, a driver may wish to be in complete control of the vehicle during a certain stage of a journey, and relinquish some or all of their control to an autonomous control system during another stage of the journey. The present disclosure provides a method and system that adjusts the level, for example a proportion, of autonomous control of the vehicle based on a combination of manual control factors.

In the context of the present disclosure, the term “manual control factor” is understood to be any factor relating to: an operational parameter of the vehicle that may be influenced by a driver's manual control of the vehicle; and/or an ability of the driver to control the vehicle manually. For example, the manual control factor of a vehicle may depend upon the driver's operation of a throttle pedal of the vehicle in combination with a physical state of the driver. The method and system is discussed below in further detail.

The United States National Highway Traffic Safety Administration (NHTSA) defines levels of autonomous control in five discrete levels. It is understood, however, that the proportion of autonomous control may be varied by any appropriate amount, irrespective of the levels defined by the NHTSA. By way of example, however, and to aid the understanding of the present disclosure, reference will be made in the following description to the levels of autonomous control defined by the NHTSA, which may be:

No-Automation (Level 0): The driver is in complete and sole control of the primary vehicle controls—brake, steering, throttle, and motive power—at all times.

Function-specific Automation (Level 1): Automation at this level involves one or more specific control functions. Examples include electronic stability control or automatic braking, where the vehicle automatically assists with braking to enable the driver to regain control of the vehicle or stop faster than would be possible acting alone.

Combined Function Automation (Level 2): This level involves automation of at least two primary control functions designed to work in unison to relieve the driver of control of those functions. An example of combined functions enabling a Level 2 system is adaptive cruise control in combination with lane centering.

Limited Self-Driving Automation (Level 3): Vehicles at this level of automation enable the driver to handover full control of all safety-critical functions under certain traffic or environmental conditions and, in those conditions, to rely heavily on the vehicle to monitor for changes in those conditions requiring transition back to driver control. The driver is expected to be available for occasional control, but with sufficiently comfortable transition time.

Full Self-Driving Automation (Level 4): The vehicle is designed to perform all safety-critical driving functions and monitor roadway conditions for an entire trip. Such a design anticipates that the driver will provide destination or navigation input, but is not expected to be available for control at any time during the trip. This includes both occupied and unoccupied vehicles.

In the context of the present disclosure, the term “autonomous vehicle” applies to any vehicle capable of controlling at least one vehicle function autonomously. For example, an autonomous vehicle may be a semi-autonomous vehicle having the capability to control the vehicle according to one or more levels of autonomous control defined by Level 1 to Level 3 above. In another arrangement, the autonomous vehicle may be a fully-autonomous vehicle having the capability to control the vehicle according to one or more levels of autonomous control defined by Level 4 above.

It is also understood that the term “autonomous vehicle” applies to any vehicle in which an autonomous control system may be activated to provide and/or adjust the level of autonomous control of the vehicle, for example as a function of one or more manual control factors.

The present disclosure may provide a method and system that adjusts the level, for example a proportion, of autonomous control in order to enhance driver experience, for example pleasure and/or entertainment of the driving experience. For instance, the level of autonomous control of the vehicle may be adjusted so that the driver experiences an enhanced level of speed and/or handling of the vehicle. In this manner, the driver may have a “racetrack” experience, despite the vehicle operating at substantially normal, i.e. road legal, driving conditions. Such an enhanced experienced may be achieved through augmentation of input by the driver to the controls of the vehicle, so that the vehicle operates in a more sporting manner than would normally be achieved for a given input level by the driver to the controls of the vehicle.

The level of autonomous control of the vehicle may be adjusted so that the driver is able to operate the vehicle in a manner that is beyond the physical capabilities of the driver. For example, if a vehicle is capable of travelling on a racetrack at 180 kph, but the driver's skill and/or confidence level renders him unable to safely drive at that speed, the level of autonomous control of the vehicle may be adjusted to enhance the driver's capabilities so that the vehicle travels on the racetrack at a speed greater than that allowed by the driver's skill and/or confidence level. For example, the level of autonomous control of the vehicle may be adjusted to attain a speed between a lower speed prescribed by a skill and/or confidence level of the driver and a higher speed defined by physical limits of the vehicle on the racetrack.

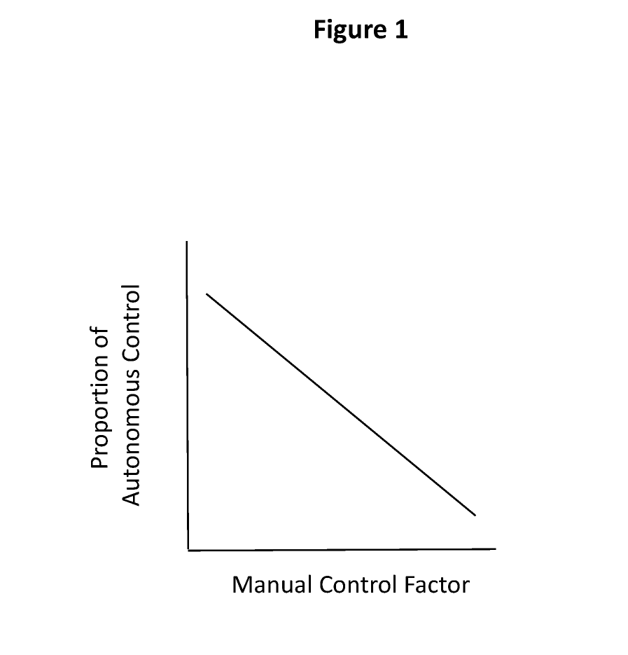

FIG. 1 shows a graphical representation of how the proportion of autonomous control may vary depending on a combination of manual control factors. A first type of manual control factor may be an operational parameter of the vehicle resulting from manual control of the vehicle. Another type of manual control factor may be any factor that may affect the ability of the driver to control the vehicle manually.

For example, the operational parameter may be the vehicle speed, which may be changed as a result of the input to one or more controls of the vehicle, such as a throttle pedal and/or a brake pedal of the vehicle. The operational parameter may be vehicle direction, which may be changed as a result of the input to one or more controls of the vehicle, such as a steering system of the vehicle and/or the selection of forward and reverse gears of the vehicle. The operational parameter may be a rate of change of a vehicle direction, caused by driver input to a steering system of the vehicle. The operational parameter may be the proximity of the vehicle to one or more other vehicles and/or an article of road furniture, for example a barrier, caused by driver input to at least one of the vehicle's controls. The operational parameter may be the fuel economy of the vehicle, which may be affected by the manner in which the driver is controlling the vehicle. For example, where the driver chooses to accelerate quickly, the fuel economy of the vehicle is lower than when the driver chooses to accelerate slowly. The operational parameter may be the route of the vehicle. For example, the route of the vehicle may be affected by a decision to go one way or another at a particular junction. It is appreciated, therefore, that the one or more operational parameters of the vehicle may be the result of one or more inputs by a driver and/or passenger of the vehicle to one or more controls of the vehicle.

For the other type of manual control factor, the ability of the driver to control the vehicle manually may depend on one or more factors that are outside of the control of the driver. For example, the ability of the driver to control the vehicle manually may depend on the conditions of the environment external to the vehicle, the physical state of the driver and/or the functional state of the vehicle. In one arrangement, the driver's ability to control the vehicle manually may be affected when it rains heavily, when the driver is tired, and/or if one or more systems of the vehicle are not functioning correctly.

The present disclosure therefore provides a method and system that adjusts the proportion of autonomous control of the vehicle depending on at least one operational parameter that is affected by a manual input into at least one vehicular system, and the ability of the driver to control the vehicle manually.

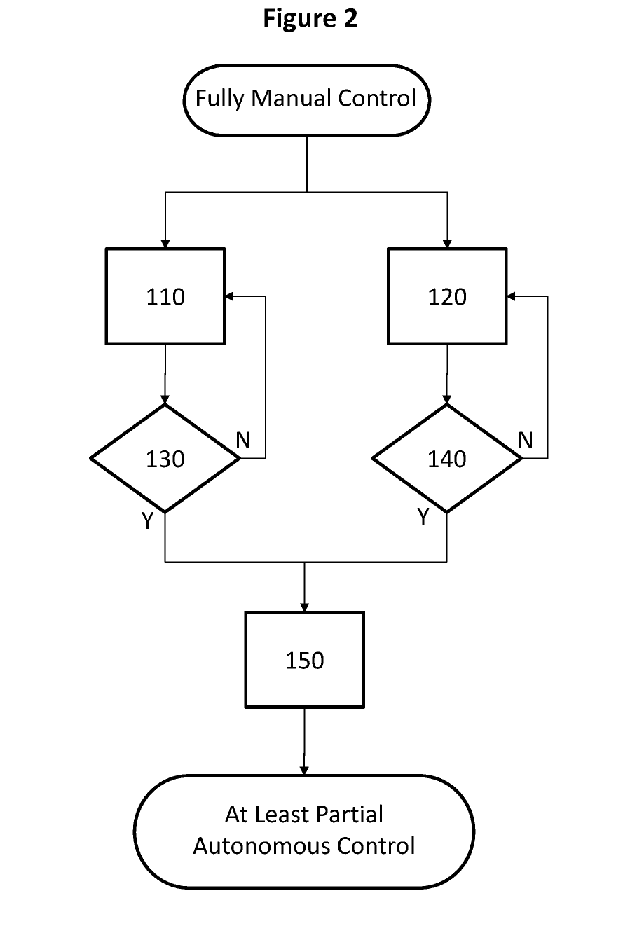

The method to adjust the proportion of autonomous control of the vehicle will now be described with reference to the flow chart shown in FIG. 2, and the above described levels of autonomous control.

The method may comprise a first step 110 to determine an operational parameter of the vehicle. For example, the method may comprise determining a proximity of the vehicle in relation to a barrier next to which the vehicle is travelling. A position of the vehicle being a result of a drivers input into the steering system of the vehicle. The method may further comprise a second step 120 to determine an ability of the driver to control the vehicle. For example, the method may comprise determining the weather conditions external to the vehicle. The weather conditions being a direct influence on the driver's ability to control the vehicle manually. As such, when the vehicle is travelling in heavy rain, the driver may have less control over the vehicle as a result of the rain, and therefore a lower ability to control the vehicle manually.

The method may comprise a first comparison step 130 to determine if at least one operational parameter of the vehicle is greater or less than a predetermined operational parameter threshold, i.e. if the vehicle is too close to the barrier next to which the vehicle is travelling. In a similar manner, the method may comprise a second comparison step 140 to determine if the ability of the driver to control the vehicle manually is greater or less than a predetermined ability threshold, e.g. if the road conditions due to the rain are sufficient to lower the driver's ability to control the vehicle below a certain threshold.

The method may comprise a step 150 to adjust the proportion of autonomous control of the vehicle based on, in this case, the proximity of the vehicle in relation to the barrier and the weather conditions in which the vehicle is travelling. In this manner, when it is determined that the vehicle is travelling too close to the barrier, and that the driver has a decreased ability to control the vehicle manually, the method may comprise increasing the proportion of autonomous control in order to change one or more operational parameters of the vehicle, and change a determined ability of the driver to control the vehicle manually.

The proportion of autonomous control may be adjusted in any appropriate manner. For the above described arrangement, the proportion of autonomous control may be adjusted by autonomously steering the vehicle away from the barrier, and/or by preventing the driver from steering any closer to the barrier. The proportion of autonomous control may not be limited to a single adjustment of an operational parameter of the vehicle, and may in fact involve adjustment of a plurality of operational parameters of the vehicle. For example, in addition to or instead of autonomously adjusting the steering system of the vehicle, the proportion of autonomous control may be adjusted to slow the vehicle to a speed at which the ability of the driver to control the vehicle manually is acceptable.

In another arrangement, the method may comprise determining the speed of the vehicle as a direct result of the driver's operation of a throttle pedal of the vehicle. The method may also comprise determining a physical state of the driver, for example determining a state of mental alertness of the driver. Accordingly, the method may comprise adjusting the proportion of autonomous control when it is determined that a driver's state of mental alertness is insufficient to control the vehicle at the speed that the driver is operating the vehicle. In such an example, the proportion of autonomous control may be adjusted by increasing the level of autonomous control such that the driver has less influence over the throttle control of the vehicle, and/or a steering system of the vehicle. For example, the method may comprise increasing resistance to the throttle pedal being depressed and/or resistance to turning of the steering wheel when the vehicle is being turned.

In this manner, when it is determined that the driver of the vehicle is no longer able to control the vehicle in a safe manner, the autonomous control system according to the present invention increases the level of autonomous control to provide a safer driving experience.

The method may comprise selecting a driving mode to define a threshold of the one or more operational parameters. For example, the method may comprise selecting a driving mode in which a speed of the vehicle is limited, for example to a speed below the speed limit of the road on which the vehicle is travelling.

The proportion of autonomous control may be adjusted by an amount depending on the difference between the one or more operational parameters and a threshold of the one or more operational parameters. In one scenario, the driver may be controlling the vehicle such that the vehicle is only travelling at, or slightly over, the speed limit, for example at a speed of 32 miles per hour (mph) on a portion of road where the speed limit is 30 mph. In such a scenario, the proportion of autonomous control may be adjusted to decrease a throttle response of the vehicle by a small amount in order to effect a reduction in speed of 2 mph. The autonomous control system of the vehicle may be configured to adjust throttle response in such a manner that the driver is unaware that there has been any significant effect on the performance of the vehicle. In another scenario, the vehicle may be travelling at a speed much higher than the speed limit, for example at a speed of 110 mph on a portion of road where the speed limit is 70 mph. In such a scenario, the proportion of autonomous control may be adjusted to operatively disconnect a motor of the vehicle from the throttle pedal, such that the driver is no longer able to manually effect an increase in the speed of the vehicle by depressing the throttle pedal. Additionally or alternatively, the proportion of autonomous control may be adjusted by operating a brake system of the vehicle in order to reduce the speed of the vehicle to the desired speed, which in this case is 70 mph.

In another arrangement, a driving mode may be selected in which the driver wishes to maintain a position of the vehicle within a lane of a road on which the vehicle is travelling. In such a case, the proportion of autonomous control may be adjusted by an amount that is proportional to the input to a steering system of the vehicle. For example, where the driver of the vehicle performs a manual input into the steering system that would result in a small deviation away from a center of the lane, it may be determined that a driver's ability to control the vehicle manually along a route corresponding to the center of the lane is only slightly impaired. In this scenario, the proportion of autonomous control applied to the steering system need only be small, and may not be perceived at all by the driver.

In one arrangement, the method may comprise providing feedback to the driver in order to influence a driver's natural driving tendencies. For example, the method may comprise providing sensory/haptic feedback to the driver by virtue of the controls of the vehicle and/or through a seat of the vehicle, in order to influence a driver's natural driving tendencies in order to achieve a better/faster/safer/other driving experience.

In one arrangement, the level of autonomous control may be adjusted in a manner that is so subtle that the driver may not perceive a change in the level of autonomous control. For example, the level of autonomous control may be increased so gradually that the driver does not notice any significant change in the manner in which the vehicle responds to the inputs to the controls of the vehicle.

It will be appreciated by those skilled in the art that although the invention has been described by way of example with reference to one or more arrangements, it is not limited to the disclosed arrangements and alternative arrangements could be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method to control an autonomous vehicle, comprising:
determining an operational parameter and a driver ability to manually control a system;
selecting a driving mode to define a threshold of the operational parameter; and
adjusting a proportion of autonomous control of the vehicle based on the operational parameter according to a difference between the operational parameter and the threshold of the operational parameter in combination with the ability of the driver.

2. The method according to claim 1, wherein the operational parameter includes at least one of:
a vehicle speed;
a rate of change of vehicle direction;
a proximity of the vehicle to one or more other vehicles;
a proximity of the vehicle to one or more items of road furniture;
a fuel economy of the vehicle; or
a route of the vehicle.

3. The method according to claim 1, wherein the driver ability to control the vehicle manually includes at least one of:
conditions of an environment external to the vehicle;
a physical state of the driver; or
a functionality of the vehicle.

4. The method according to claim 1 further comprising increasing the proportion of autonomous control when the operational parameter is outside of the threshold.

5. The method according to claim 1, wherein the driving mode maximizes fuel economy of the vehicle.

6. The method according to claim 1, wherein the driving mode maximizes driver safety.

7. The method according to claim 1, wherein the driving mode maximizes vehicle reliability.

8. The method according to claim 1, wherein the driving mode minimizes journey time.

9. The method according to claim 1 further comprising providing a warning to the driver that the proportion should be increased based on the operational parameter and the ability of the driver.

10. An autonomous control system for a vehicle, comprising:
a controller configured to, in response to an operational parameter having a threshold identified according to a selected driving mode and a driver ability to manually control a vehicle system, adjust a proportion of autonomous control of the vehicle based on the operational parameter according to a difference between the operational parameter and the threshold of the operational parameter in combination with the driver ability.

11. The autonomous control system according to claim 10 further comprising one or more sensors operatively connected to the controller, the one or more sensors being configured to determine the operational parameter corresponding to one or more of:
a vehicle speed;
a rate of change of vehicle direction;
a proximity of the vehicle to one or more other vehicles;
a proximity of the vehicle to one or more items of road furniture;
a fuel economy of the vehicle; or
a route of the vehicle.

12. The system according to claim 10 further comprising one or more sensors operatively connected to the controller, the one or more sensors being configured to determine the ability of a driver to control the vehicle manually via:
a determination of conditions of an environment external to the vehicle;
a determination of a physical state of the driver; or
a determination of a functionality of the vehicle.

13. A vehicle comprising:
first sensors configured to determine a vehicle operational parameter;
second sensors configured to determine an ability of a driver to manually control the vehicle; and
a controller configured to, in response to the vehicle operational parameter having a threshold identified by a selected driving mode and the ability of the driver, adjust a proportion of autonomous control of the vehicle based on the operational parameter according to a difference between the operational parameter and the threshold of the operational parameter in combination with the ability of the driver.

14. The vehicle according to claim 13, wherein operational parameter is one of:
a vehicle speed;
a rate of change of vehicle direction;
a proximity of the vehicle to one or more other vehicles;
a proximity of the vehicle to one or more items of road furniture;
a fuel economy of the vehicle; or
a route of the vehicle.

15. The vehicle according to claim 13, wherein the ability of the driver includes a determination of conditions of an environment external to the vehicle, a determination of a physical state of the driver, and a determination of a functionality of the vehicle.

16. The vehicle according to claim 13, wherein the selected driving mode maximizes fuel economy.

17. The vehicle according to claim 13, wherein the selected driving mode maximizes driver safety.

18. The vehicle according to claim 13, wherein the selected driving mode maximizes vehicle reliability.

19. The vehicle according to claim 13, wherein the driving mode minimizes journey time.

20. The vehicle according to claim 13, wherein the controller is further configured to provide a warning that the proportion is increasing based on the operational parameter and the driver ability.
